(19) United States
(12) Patent Application Publication
(10) Pub. No.: US 2009/0138131 A1
(43) Pub. Date: May 28, 2009

(54) Residential Environmental Management control System with Sprinkler Control Module

(75) Inventor: Dindo Uy, North Hollywood, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Zodiac Pool Systems, Inc., Moorpark, CA (US)

(21) Appl. No.: 12/255,598

(22) Filed: Oct. 21, 2008

Related U.S. Application Data
(60) Provisional application No. 60/981,785, filed on Oct. 22, 2007.

(51) Int. Cl. G05D 7/06

(52) U.S. Cl. 700/284

(57) ABSTRACT

A residential environmental management control system may include a master control and a sprinkler module. The system may include a user interface and/or a power supply. The system may include a housing for the master control and the sprinkler module.

### RELATED APPLICATIONS

This application claims the benefit under 37 C.F.R. § 119(e) to U.S. Provisional Patent Application No. 60/981,785, filed Oct. 22, 2007, and entitled “Residential Environmental Management Control System with Sprinkler Control Module,” the entire disclosure of which is incorporated herein by reference. This application is related to U.S. Provisional Patent Application No. 61/015,562, filed Dec. 20, 2007, and entitled “Residential Environmental Management Control System with Automatic Adjustment,” the entire disclosure of which is incorporated herein by reference. This application is also related to U.S. patent application Ser. No. ______ (Attorney Docket No. 189656/US2), filed concurrently herewith, which claims the benefit of U.S. Provisional Patent Application No. 60/981,778, filed Oct. 22, 2007, and entitled “Residential Environmental Management Control System Interlink,” the entire disclosures of which are incorporated herein by reference.

### TECHNICAL FIELD

The present invention relates to environmental management systems and devices. More specifically, the present invention relates to residential environmental management control systems including sprinkler control.

### BACKGROUND

Commercial and residential systems and devices are known for controlling pools, spas and associated water features. Other systems and devices are known for separately controlling other residential environmental management systems, such as security systems, outdoor lighting systems or automatic sprinkler systems. Residential environmental management systems are typically powered systems that include user interfaces that allow a user to program various functions and view system status.

### BRIEF SUMMARY

In addition to multiple user interfaces for each separate system, the user interfaces may be in a different location. The control systems may also be in several different locations. Thus, there exists a need in the art for a residential environmental management system that can control more than one system from a common location, a common user interface and/or a common power source.

Disclosed herein is a residential environmental management control system comprising a master control and a sprinkler module. The system may include a user interface and/or a power supply. The system may include a housing for the master control and the sprinkler module.

Disclosed herein is a kit for a residential environmental management system comprising a master control and a sprinkler module. The kit may include a user interface and/or a power supply. The kit may include a housing for the master control and the sprinkler module. The kit may include an instruction or user's manual.

In various embodiments, the master control and sprinkler module may be powered in parallel or daisy chained. In various embodiments, the master control and sprinkler module may be housed within the same housing. In various embodiments, the sprinkler module and master control may be adapted for use by a single user interface. In various embodiments, the sprinkler module may be configured to be directly controlled by the master control. In various embodiments, the master control and the sprinkler module may be powered by the same power supply.

In various embodiments, methods of using a sprinkler module and master control may be provided. For example, such methods may involve controlling a sprinkler system using a master control, a sprinkler module and/or a user interface.

While multiple embodiments are disclosed, still other embodiments of the present disclosure will become apparent to those skilled in the art from the following Detailed Description, which shows and describes illustrative embodiments of the invention. As will be realized, the present disclosure is capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 is a block diagram depicting a typical residential environment.

FIG. 2 is a block diagram depicting a typical residential environment including an installation of a residential environmental management system.

FIG. 3 depicts a residential environmental management system including a master control, a sprinkler module and a user interface.

FIG. 4 depicts the residential environmental management system of FIG. 3 including a power supply.

FIG. 5 depicts an isometric proximal view of an embodiment of a sprinkler module board for a the residential environmental management system.

FIG. 6 depicts an expanded rear view of the sprinkler module board of FIG. 5 and mounting hardware.

FIG. 7 depicts a plan view of another embodiment of a sprinkler module board.

FIG. 8 depicts the sprinkler module board of FIG. 5, wherein the sprinkler module may operably connected to sprinkler valves.

FIG. 9 depicts the sprinkler module of FIG. 7, wherein the sprinkler module is shown attached to the sprinkler system.

FIG. 10 depicts an installation location wherein the sprinkler module of FIG. 5 may operably connected to the master control.

FIG. 11 depicts an alternative location for installation of the sprinkler module of FIG. 1.

FIG. 12 is a circuit diagram of the sprinkler module of FIG. 5.

FIGS. 13-19 are examples of a series of displays that may be provided by the user interface for interacting with the master control and the sprinkler control module.

### DETAILED DESCRIPTION

As described further below, various ways of expanding the capability, practicality and/or convenience of residential environmental management systems are contemplated. In particular, the approaches contemplated herein are directed to employing a sprinkler module to address various design constraints and practical considerations involved with residential environmental management systems.

The design of residential environmental management control systems differs fundamentally from commercial installations. A commercial installation is typically designed from the ground up to be suitable for the particular application. On the other hand, residential installations are designed to be suitable for a wide variety of applications, that is, different homes with varying layout and/or systems to be controlled. Residential installations take advantage of the fact that each home will generally have a basic layout and/or number of systems to be controlled. Thus, a single master control unit or a limited number of variants may be designed to address most residential needs.

This fundamental difference is evident in the costs and business competitiveness of such systems. On the commercial side, the costs may be quite high, hundreds of thousands of dollars or more, as the management system is designed for the particular job, and the competitive marketplace may be defined primarily by the reputation of the designer. On the residential side, costs are typically much lower, ranging from less than a thousand dollars to a few thousand dollars, and the competitive marketplace may be defined primarily by the cost and reputation of the products.

From a competitive standpoint, residential environmental management control systems thus may be designed to be suitable for most residential applications, controlling the basic cost of the systems by limiting the capability and/or capacity of the systems to what is typically required. For example, a residential environmental management control system may be designed to have several different master control models, including one configured to control a pool or a spa, a second configured to control both a pool and a spa using shared equipment, and a third configured to control a pool and a spa using separate equipment. Each of the master control models may have a predetermined capability or capacity to control other residential environmental systems, for example, via a predetermined number of auxiliary outputs. Such an approach may provide a certain amount of flexibility to suit a large number of residential applications without a need to design a wide range of master control models, which may unduly increase costs and reduce competitiveness.

Thus, for a residential application, the master control model(s) may be configured to control a conventional sprinkler system, such as described herein. However, because conventional sprinkler systems are typically divided into a plurality of zones, for example, to maintain water pressure for proper operation and/or to allow differing amounts of watering for different areas, a plurality of outputs of the master control may typically be required to control a sprinkler system.

As it may be desirable to limit the number of outputs for residential master controls, for example, from a cost-competitiveness standpoint, connecting a sprinkler system to a residential master control may use many, most or even all, of the outputs of the master control. This may not leave any or enough outputs of the master control available for connecting other systems to be controlled. From a cost standpoint, a customer may not wish to incur the expense of installing an additional master control to provide any additional needed outputs.

The approaches described herein employing a sprinkler module allow for a residential environmental management control system to be configured to control a sprinkler system without requiring as many outputs of the master control as may be required by directly connecting the sprinkler system to the outputs of the master control. Thus, a customer may select to have a sprinkler module installed at a relatively lower additional cost than would be required for an additional master control. Further, a customer not needing or wanting to control a sprinkler system via the residential environmental management control system need not incur the cost of a system designed with more capacity and/or capability to accommodate control of a sprinkler system with control of other systems. Further, no additional master control models need be designed, for example, to provide sprinkler control models and non-sprinkler control models.

Thus, it should be understood that the approaches described herein provide distinct benefits to residential environmental management systems. However, it should also be understood that the approaches described herein may be employed in commercial applications, as appropriate or desired, particularly where a ground-up design is not desired, for cost considerations or otherwise.

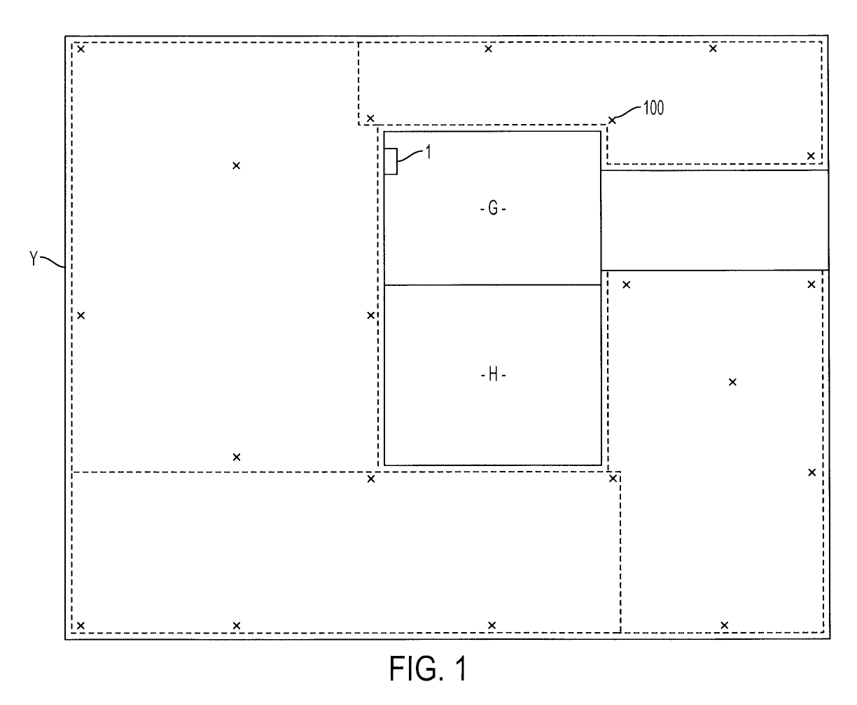

A typical residential environment is illustrated in FIG. 1, including a house H, with an attached garage G and a surrounding yard Y. As represented by each “x” in FIG. 1, sprinkler heads of a sprinkler system 100 may be disposed about the yard Y to provide irrigation of the lawn and/or other plants therein. As depicted by dashed lines, the sprinkler heads of the sprinkler system 100 may be grouped into various zones, as discussed above. The sprinkler system 100 may include a conventional controller 1, for example, disposed in the garage G. As discussed above, the controller 1 may be configured to provide control of the sprinkler system 100 on a zone-by-zone basis, as appropriate or desired.

The present application describes a residential environmental management (REM) system 5. The present application also discloses a kit comprising the REM system 5. In one embodiment, the REM system 5 includes a master control 10 and a sprinkler module 15. The sprinkler module 15 may be housed in the same housing with the master control 10. The master control 10 may be configured to directly control the sprinkler module 15. The REM system 5 may include a user interface 20. It should be understood that an additional user interface(s) may be included, for example, remote from the master control 10, either wired or wirelessly connected. In another embodiment, the REM system 5 may include a power supply 25. The sprinkler module 15 and the master control 10 may utilize the same power supply 25. Thus, the present system may provide the following advantages, including but not limited to, cost effectively and efficiently controlling more than one residential environmental management system from a single master control 10 and accessing the system via a single or common user interface 20. Further, where the sprinkler module 15 and the master control 10 share a housing, there is no need for a separate housing, thereby reducing costs and saving space. Also, the shared power supply 25 may eliminate the need for a separate power supply, thus also reducing costs and complexity. Further, where the sprinkler module 15 is directly controlled by the master control 10, the outputs available on the master control 10 can be used to automate or control other devices or systems.

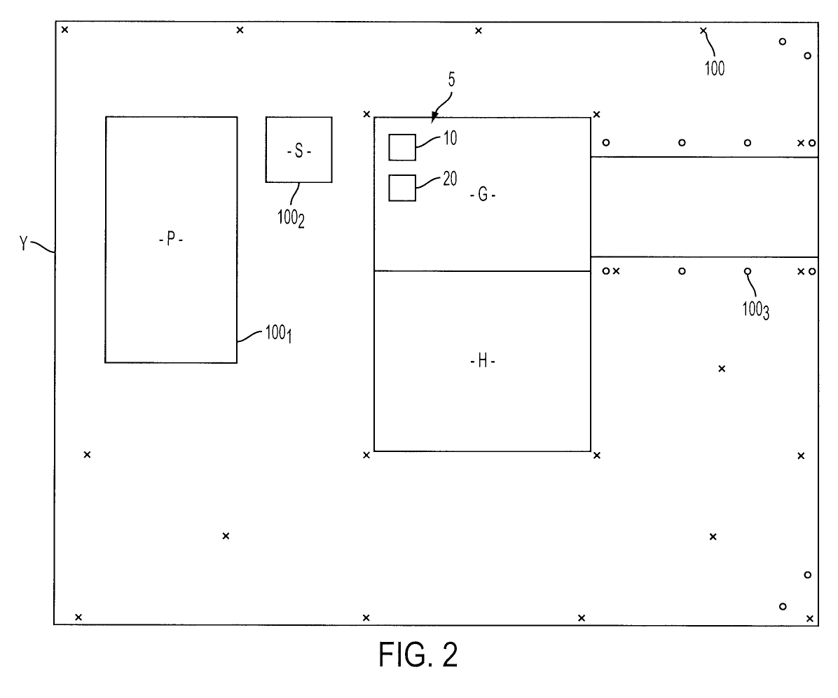

The REM system 5 may be employed, for example, to control various residential environmental systems, including the sprinkler system 100 shown in FIG. 1. For example, as illustrated in FIG. 2, the owner of the house H may choose to have a pool P, a spa S, outdoor lighting (depicted by a plurality of “o”), and/or other systems (not shown) installed. The owner may also choose to have the REM system 5 to control all of these systems, including the sprinkler system 100.

An embodiment of the REM system 5 may include a master control 10 and a common user interface 20. Various outputs of the master control 10 may be placed in communication with controls of the various systems 100, 100₁, 100₂, 100₃ to be controlled. As each of the systems 100, 100₁, 100₂, 100₃ to be controlled may include various sub-systems, such as a pump and/or filter, heater, chlorinator, and the like for the pool P and/or the spa S, to be controlled, it should be readily understood that the outputs of the master control 10, which may be limited in number as discussed above, may be easily used up. Thus, it may be necessary to add a second master control 10 to provide more outputs, particularly where the systems to be controlled include the sprinkler system 100 having a plurality of zones requiring individual outputs for control.

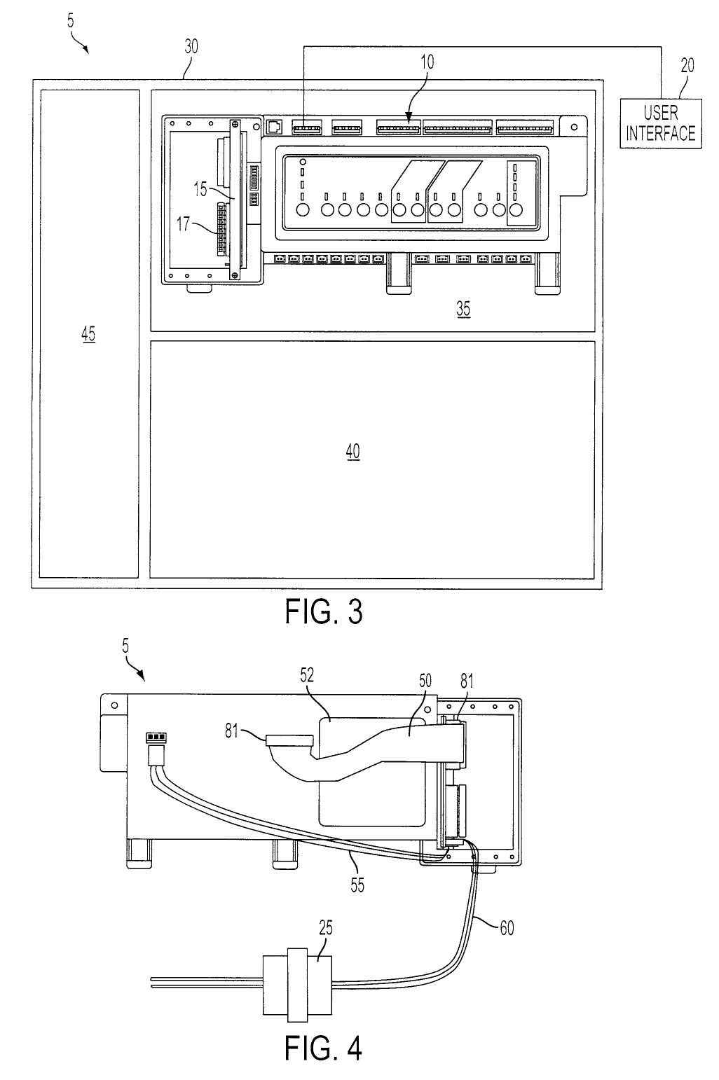

However, a solution as described herein is to provide a sprinkler module 15 to be added to the REM system 5 so that the master control 10 may control the sprinkler system 100 via the sprinkler module 15. One embodiment of the REM system including the master control, the sprinkler module 15 and a power supply 25 is illustrated in FIGS. 3 and 4. FIG. 3 depicts the REM system 5 including the master control 10, the sprinkler module 15, and the user interface 20. FIG. 4 depicts the REM system 5 of FIG. 3 including the power supply 25. In one embodiment, the master control 10 is the AQUALINK® RS from Jandy Pools, Inc.

As shown in FIG. 3, the REM system 5 includes a user interface 20. In one embodiment, the user interface 20 is the AQUALINK® RS User Interface from Jandy Pools, Inc. The REM system 5 may be located on a power center can (housing) 30 with areas of low voltage 35 and high voltage 40, e.g., low voltage for control components and high voltage for controlled devices. The power center can 30 may have a low voltage raceway 45. As discussed in more detail below, depending on the dimensions and other factors of the system, the sprinkler module 15 may be operably connected to the master control 10 in the area of low voltage 35 as a daughter card or in the low voltage raceway 45.

As shown in FIG. 4, in addition to the elements as shown in FIG. 3, the REM system 5 may also include the power supply 25, a CPU board 52, a ribbon cable 50, a power cable extension harness 55, and a power cable 60. The sprinkler module 15 may be operably connected to the master control 10 with the ribbon cable 50. The sprinkler module 15 may also be operably connected to the master control 10 with a power cable extension harness 55. The sprinkler module 15 may be operably connected to the power supply 25 with a power cable 60.

In one embodiment, the master control 10 is operably connected to the power supply 25 via the sprinkler module 15. For example, the power supply to the master control 10 and the sprinkler module 15 may be daisy chained. The power cable 60 may be used to connect directly to the master control 10 in the absence of the sprinkler module 15. Thus, the power cable 55 may be provided with the sprinkler module 15, for example, hard wired thereto with a connector or interface corresponding to the connector or interface of the power cable 60. Such an arrangement may facilitate installation, maintenance, etc. by providing a modular approach to powering the master control 10 and the sprinkler module 15.

In one embodiment, the master control 10 is configured to control a plurality of environmental management subsystems, including, but not limited to, a pool, a spa, a sprinkler, lighting, a security system, a pool filtration or pool conditioning system, etc.

In one embodiment, the sprinkler module 15 may be directly controlled by the master control 10. For example, in such a configuration, the sprinkler module 15 may not require a separate processor. Although a separate processor may be used, such a separate processor may be a dedicated processor configured to execute functions programmed by the master control 10. This may simplify design, improve reliability and/or reduce costs. Further, the sprinkler module 15 does not require the use of the outputs of the master control 10. This does not mean that the outputs cannot be used, but that the outputs not required for the sprinkler module 15 and the sprinkler module 15 does not have to run as a separate system. One advantage of the sprinkler module 15 being directly connected to the master control 10 is a reduction in the cost of the system because a separate processor is not required. It is also advantageous to leave the outputs of the master control 10 free for use by other environmental management subsystems to further enhance the efficiency and cost effectiveness of the overall system.

In one embodiment, the master control 10 and the sprinkler module 15 run off the same or a single power supply 25. In one embodiment the power supply 25 is operably connected to the sprinkler module 15 and then transferred to the master control 10. In another embodiment, the power supply 25 may be operably connected to the master control 10, which may be operably connected to the sprinkler module 15. In another embodiment, the power supply 25 is operably connected to a third subsystem which may be operably connected to either the master control 10 or the sprinkler module 15. As such, the components may be powered in parallel or daisy chained from the single power supply 25. In one embodiment, the sprinkler module 15 and the master control 10 are located within the same housing. Although separately housing each unit 10, 15 is possible, it can be advantageous for both units 10, 15 to be in the same housing because it may reduce costs and simplify maintenance.

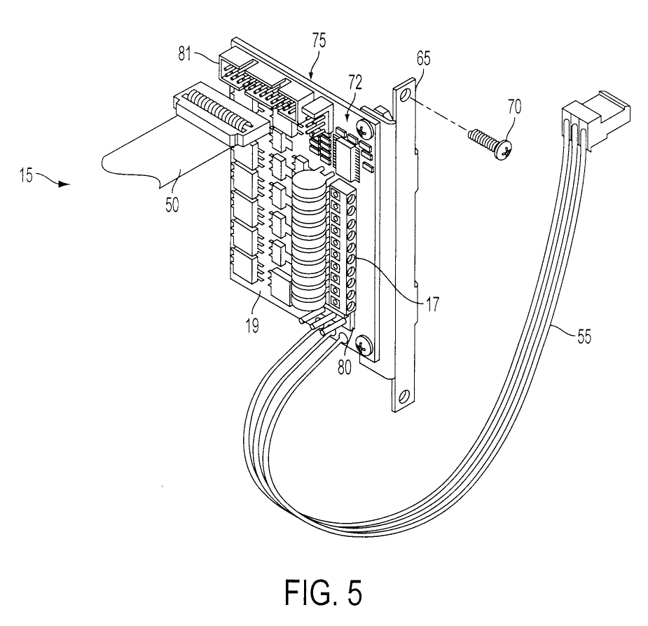

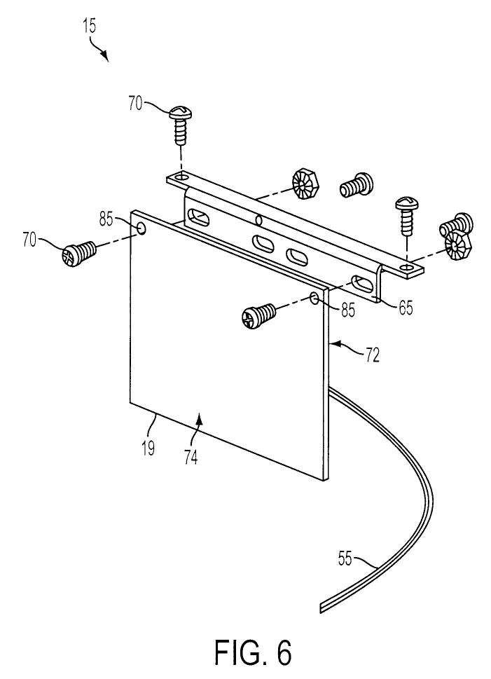

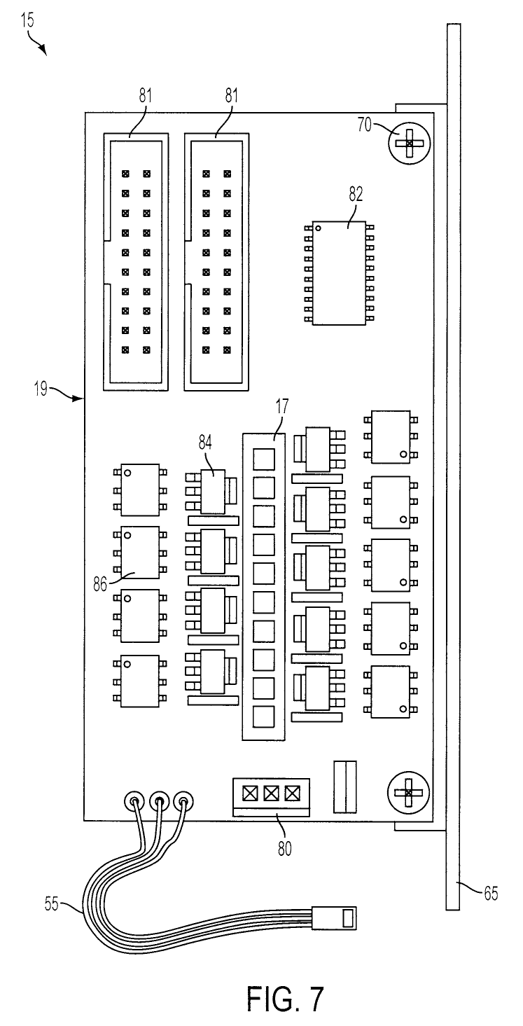

For a more detailed discussion of the component parts of the sprinkler module 15 of the REM system 5, reference is now made to FIGS. 5, 6 and 7. FIG. 5 depicts an isometric proximal view of one design of a sprinkler module board 19 of the REM system 5. FIG. 6 depicts an expanded rear view of the sprinkler module board 19 of FIG. 5 and mounting hardware 65, 70. FIG. 7 depicts a plan view of the sprinkler module board 19 of an alternative design corresponding to that of FIGS. 3 and 4.

As shown in FIG. 5, the proximal side 72 of the sprinkler module board 19 may receive a ribbon cable 50, a power cable extension harness 55, a removable terminal block 17, a mounting bracket 65 and a fastening device 70, and a printed circuit board (PCB) 75. The ribbon cable 50 and the power cable extension harness 55 may be received in respective connectors 80 (a cable port and a power supply in port) on the proximal side 72 of the sprinkler module 15. The fastening device 70 and the mounting bracket 65 may operably connect the sprinkler module 15 to the master control 10, as described in more detail below.

From FIG. 5, it should be understood that the sprinkler module 15 may be provided as a kit to be added to an existing REM system 5. For example, the kit may include the sprinkler module board 19 and mounting hardware, such as the mounting bracket 65 and fastening device 70. Additionally, the kit may include a power cable, such as the power cable extension harness 55, either attached or attachable, as appropriate or desired. Similarly, the kit may also include a communication cable, such as the ribbon cable 50, either attached or attachable, as appropriate or desired.

Referring now to FIG. 6, the distal side 74 of the sprinkler module board 19 includes apertures 85 and fastening devices 70 which may be operably connected to the mounting bracket 65 through the apertures 85. As shown in FIG. 6, the sprinkler module board 19 may be generally rectangular in shape. However, the shape of the module board 19 can be any shape that will fit within the dimensions required by the REM system 5. The fastening device 70 includes, but is not limited to a screw, rivet or any other suitable fastener.

As illustrated in FIG. 7, the sprinkler module board 19 includes the power supply in port 80 and circuits or chips 82, 84, 86. It should be understood that the circuits/chips 82, 84, 86 are intended to represent suitable circuitry for the sprinkler module board 19 to communicate with the master control 10 and to control a desired sprinkler system. As such, it should be understood that the circuitry may vary based on the particular application and/or as a matter of design choice. As described in more detail below, the sprinkler module board 19 may include ten (10) outputs, including an output for a common wire 110, a master valve 92, and eight other valves, 116, 117, 118, 119, 120, 121, 122, 123, for example.

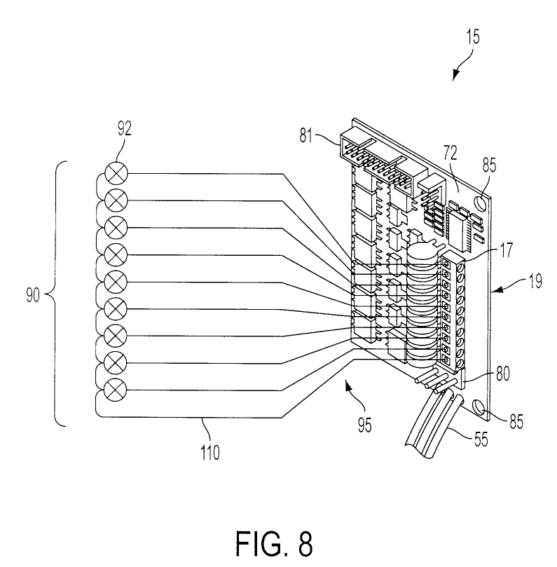

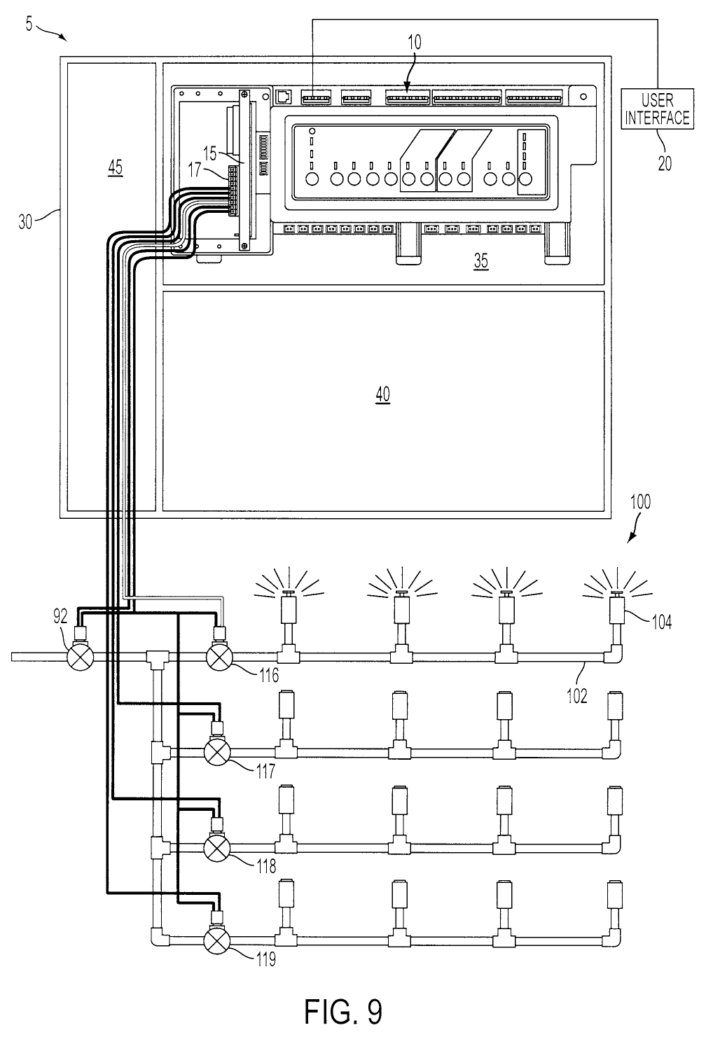

For a description of the sprinkler module 15 as it is configured for a sprinkler system 100, reference is now made to FIGS. 8 and 9. FIG. 8 depicts the sprinkler module board 19 of the REM system 5 of FIG. 5, wherein the sprinkler module 15 may be operably connected to sprinkler valves 90. FIG. 9 depicts the sprinkler module 15 of the REM system 5 of FIG. 7, wherein the sprinkler module 15 is shown connected to the sprinkler system 100.

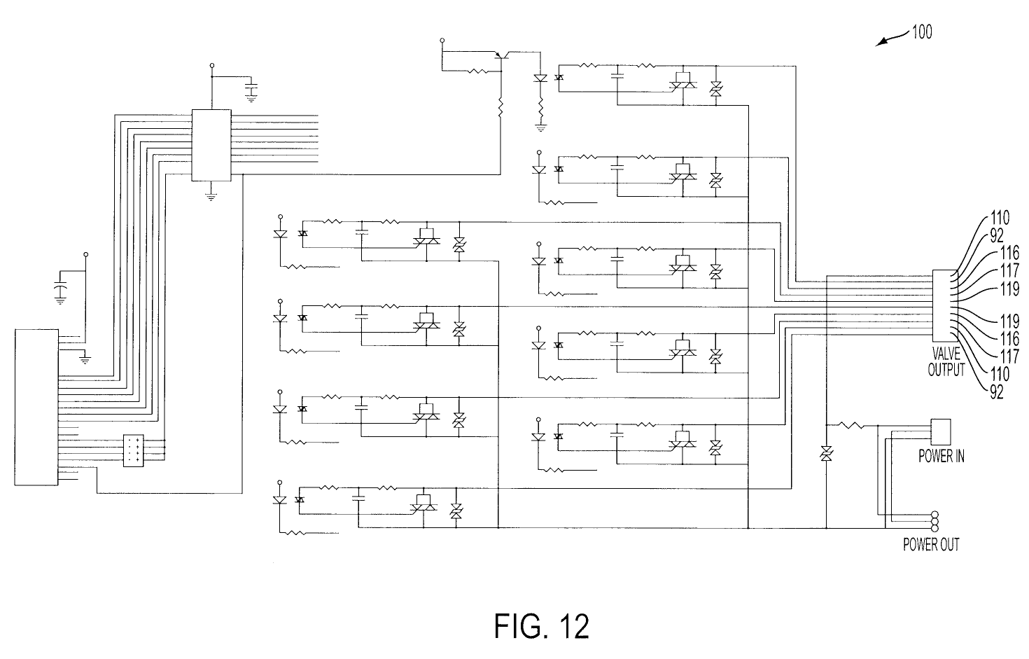

As illustrated in FIGS. 8 and 9, the sprinkler module board 19 may include wires 95 which operably connect the terminal block 17 of the sprinkler module 15 to the valves 90 of the sprinkler system 100. It should be understood that the electrical connections to the valves may be to solenoids or other suitable mechanisms thereof for opening and closing of the valves. As shown in FIG. 8, the wires 95 may be operably connected to a master valve 92 and eight (8) other valves 116, 117, 118, 119, 120, 121, 122, 123. Additionally, there may be a common wire 110. As shown in FIG. 9, there may be four (4) valves 116, 117, 118, 119 and a master valve 92. As can be understood from FIGS. 8, 12 and others, where FIG. 8 is described in more detail below, there may be a system of eight valves 116, 117, 118, 119, 120, 121, 122, 123 and an additional master valve 92. It should be appreciated that there may be more or less than eight valves and more or less than four valves depending on the configuration and requirements of the sprinkler system 100. Further, it should be understood that a sprinkler system may or may not include a master valve. The sprinkler system 100 may include zones 102 wherein a valve 116 may control the sprinklers 104 of a specific zone 102, etc.

Once installed, the sprinkler module 15 may be operated using the common user interface 20, which is used to operate the master control 10.

Various controls and/or operations may be envisioned for operating the sprinkler system 100 via the sprinkler module 15. The sprinkler module 15 may allow a user to select preset programs, enter user defined programs, enable/disable programs, alter programs, delay programs (for example, skip a day's programming by delaying 24 hours), and/or manually start/stop programs and/or operations of the sprinkler system 100 via the common user interface 20. The user may be able to set run days, start times and durations, as well as which valves are to be controlled for each program. Further, the sprinkler module 15 may be configured to run one or more programs in succession. Thus, a wide variety of programming may be implemented via the common user interface 20 to control the sprinkler system 100 via the sprinkler module 15.

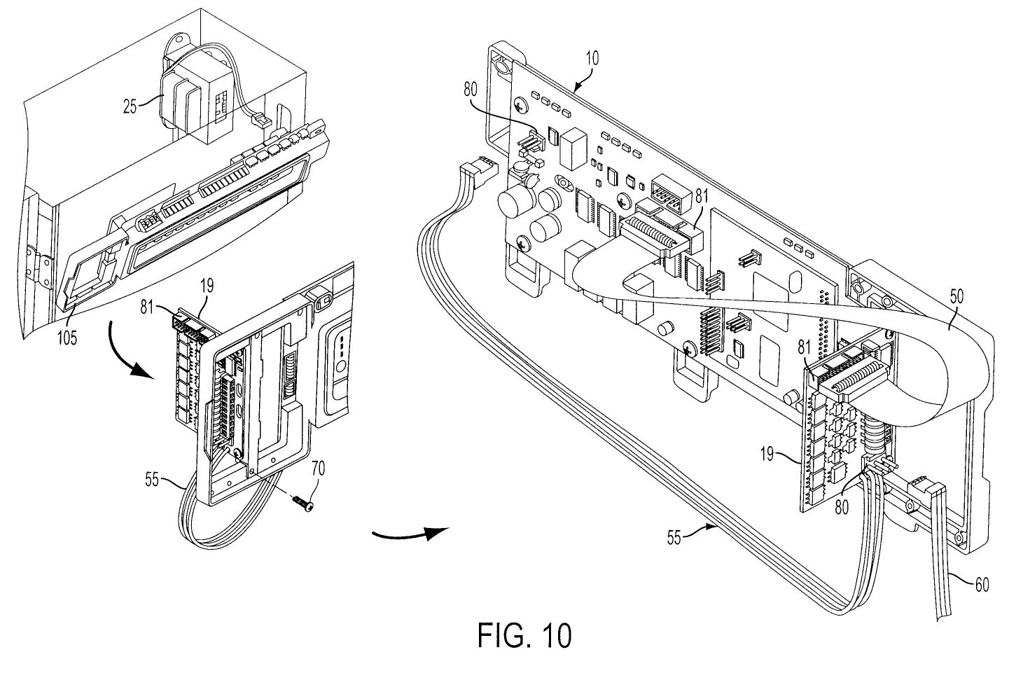

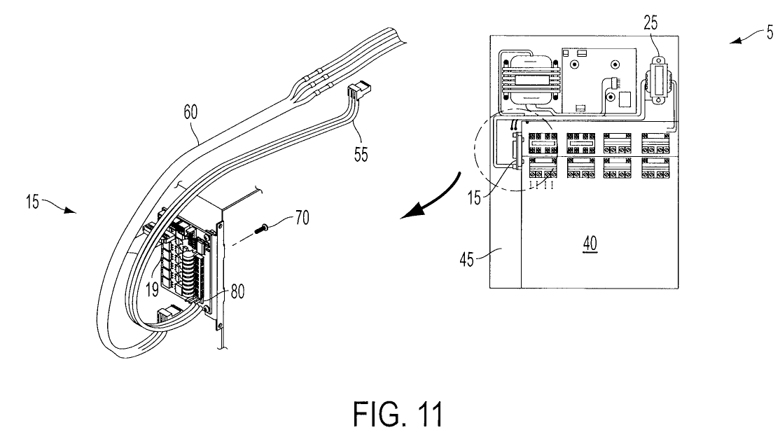

For a description of potential locations for the installation of the sprinkler module 15 onto or into the REM system 5, reference is now made to FIGS. 10 and 11. FIG. 10 depicts an installation location wherein the sprinkler module 15 of FIG. 5 is operably connected to the master control 10. FIG. 11 depicts an alternative location, such as in the low voltage raceway 45, for installation of the sprinkler module 15. Reference is also made to FIGS. 5 and 6 and others, which depict the mounting hardware 65, 70 which may be used in the installation of the sprinkler module 15.

As shown in FIG. 10, the sprinkler module 15 may be operably connected to the master control 10 in the area of low voltage 35 (FIG. 3) as a daughter card, for example, to a bezel assembly 105 on the power center can 30 of the master control 10. The sprinkler module 15 may be mounted at this location with the mounting hardware 65, 70. Then, as described above, the sprinkler module board 19 of the sprinkler module 15 may be operably connected to the master control 10 with the ribbon cable 50. The power cable extension harness 55 attached to the sprinkler module board 19 may be connected to the master control 10 at the connector 80, from which the power cable 60 of the power supply 25 has been disconnected. The power cable 60 of the power supply 25 may then be connected to the connector 80 of the sprinkler module board 19.

Similarly, as shown in FIG. 11, the sprinkler module 15 may be operably connected to the low voltage raceway 45. The sprinkler module 15 may be mounted at this location with the mounting hardware 65, 70. The location of the sprinkler module 15 depends upon the dimensions and other factors of the system 5 and the mounting hardware 65, 70 may be used in any other location where the sprinkler module 15 can be installed. For example, if other daughter cards have filled the area available in the bezel assembly 105, the low voltage raceway 45 may be used.

In either case, no additional housing and/or power supply may thus be needed for the sprinkler module 15. Further, the sprinkler module 15 may receive the benefit of electrical shielding from the high voltage area 40 provided by the housing 30 by being mounted in the low voltage areas. It should also be understood that multiple sprinkler modules 15 may be installed, in either or both areas, for example, by not only daisy chaining the power cables 55, 60, but also daisy chaining multiple ribbon cables 50 between the sprinkler module boards 19 and then to the master control 10. In such a manner, the capability of the sprinkler module(s) 15 may be expanded to accommodate sprinkler systems 100 with more valves.

Referring now to FIG. 12, the REM system 5 with a sprinkler module 15 may be set up to control a four or eight valve sprinkler system 100. FIG. 12 is a circuit diagram of the sprinkler module of FIG. 3. It should be appreciated that the REM system 5 with a sprinkler module 15 may have more or less than a four valve sprinkler system 100 and more or less than an eight valve sprinkler system 100. As shown in FIG. 12, a single power source 25 powers the system. It should be understood that any appropriate circuitry may be employed and that the circuit of FIG. 12 is only for illustrative purposes. As with the circuits/chips discussed above, the particular circuitry may vary based on the particular application and/or as a matter of design choice.

As mentioned previously, the sprinkler module 15 may be a part of a kit. In one embodiment, the kit comprises the sprinkler module 15, the mounting hardware 65, 70, the ribbon cable 50, a power cable extension harness 55, and/or an installation or instruction or user's manual. In one embodiment, the manual is a single page or sheet. In other embodiments, the manual has more than one page or sheet. The manual may include, but is not limited to, instructions for installation of the system together with or separately from its component parts. The manual may also provide instructions for use of the user interface, or instructions for setting a timer, for example. The manual may be provided with the kit or separately from the kit.

Various methods of using a sprinkler module and master control are contemplated as will be evident from the description provided above and the details provided below. Such methods are not limited to controlling a sprinkler system using a master control, a sprinkler module and/or a user interface, but encompass various installation methods and other methods of use as well.

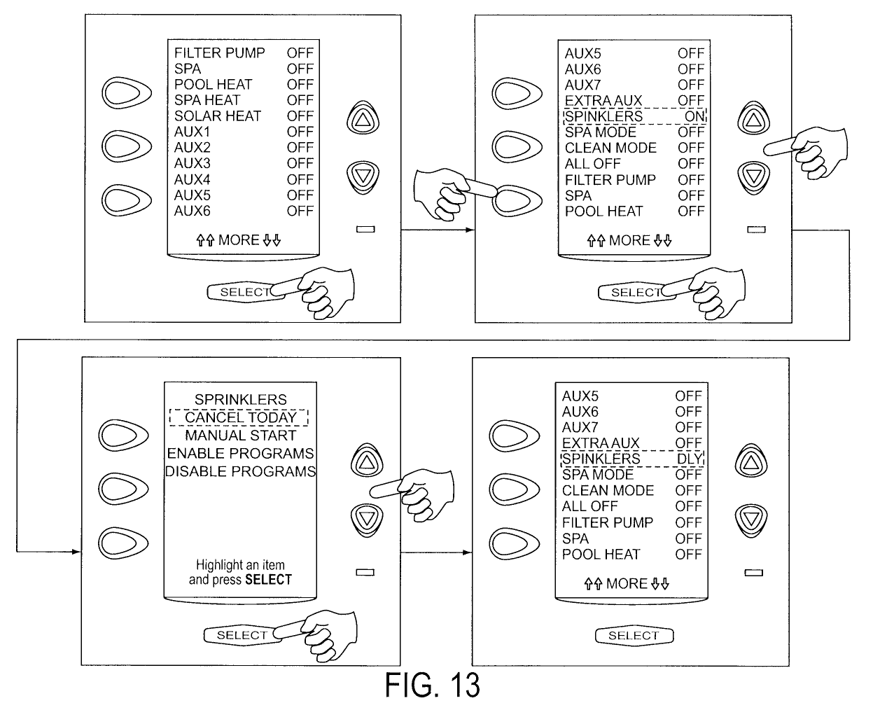

For example, as illustrated in FIG. 13, the master control of the REM system may communicate with the sprinkler module such that the sprinkler system may be controlled through a series of menus provided by the common user interface. From an initial display, a user may access any one of a plurality of preset outputs, such as “FILTER PUMP” and the like, as well as any one of a predetermined number of auxiliary outputs, such as “AUX1” and the like. One of the auxiliary outputs or a dedicated output of the master control may be identified as corresponding to the sprinkler system, that is, the sprinkler control module. For example, such output may be preset with the label “SPRINKLERS” for convenience.

A user may scroll through the main menu to highlight the “SPRINKLERS” and then press a “SELECT” button. The “SELECT” button or other buttons may toggle the sprinkler system/sprinkler control module between on and off. When on, pressing the “SELECT” button may cause a “SPRINKLERS” menu to be displayed. Various options for controlling the sprinkler system via the sprinkler control module may be provided, including but not limited to, “CANCEL TODAY” to skip a programmed watering day, “MANUAL START” to cause the sprinkler system to complete a watering cycle, “ENABLE PROGRAMS” and “DISABLE PROGRAMS.” If “CANCEL TODAY” is selected, the main menu may display a delay status of the sprinkler system as “DLY.”

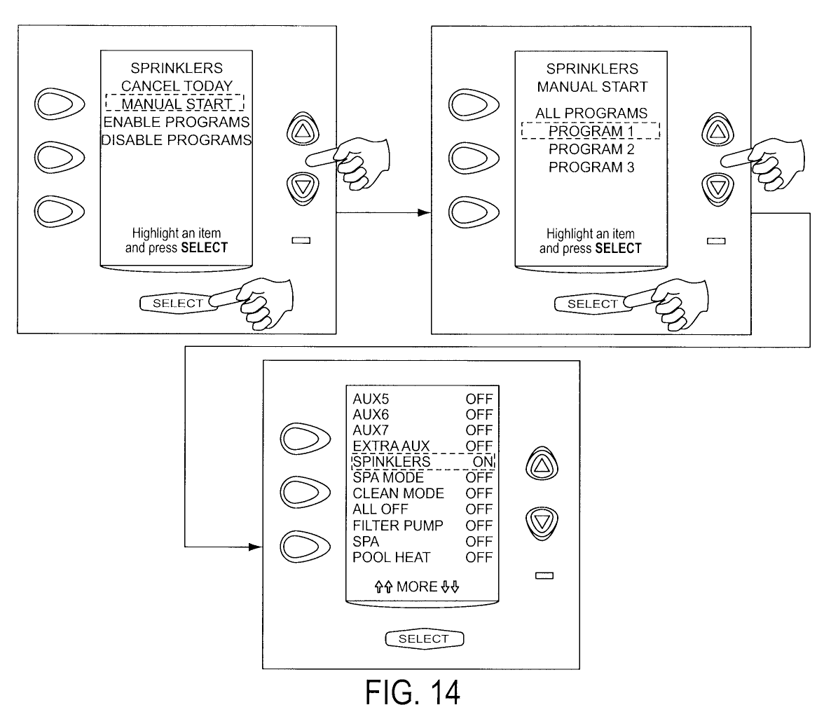

As illustrated in FIG. 14, if “MANUAL START” is selected, a “MANUAL START” menu may be displayed to provide the user with options such as running “ALL PROGRAMS” or individual programs, which may include preset programs and/or manually set programs. Once the program(s) is/are selected, the main menu may display the status of the sprinkler system as “ON.”

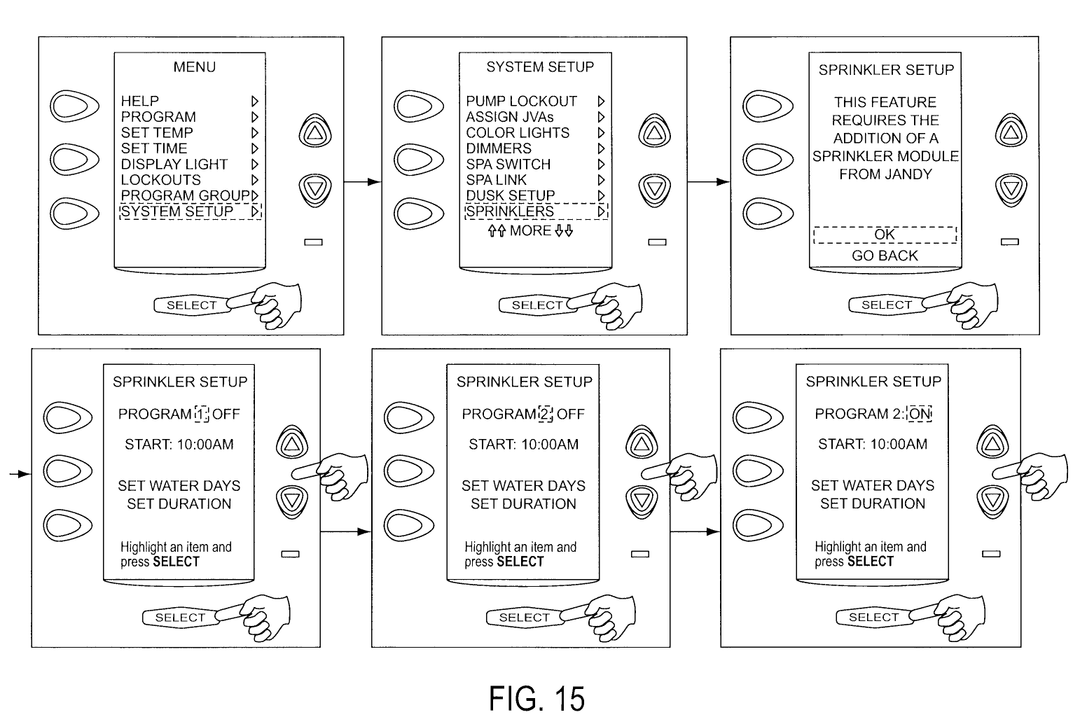

From a main “MENU” as illustrated in FIG. 15, the user may be provided with a “SYSTEM SETUP” option. If selected, among other systems, the user may be allowed to setup control of the sprinkler system by highlighting “SPRINKLERS” and pressing the “Select” button. If the sprinkler module is not installed, the “SPRINKLER SETUP” menu may display a message to the user indicating that the sprinkler module is required. Otherwise, the “SPRINKLER SETUP” menu may provide the user with suitable options for manually setting one or more programs, including start time, water days, duration, as well as zones (not shown), depending on the particular sprinkler system to be controlled. This series of menus may also allow the user to turn programs on and off for automated sprinkler control.

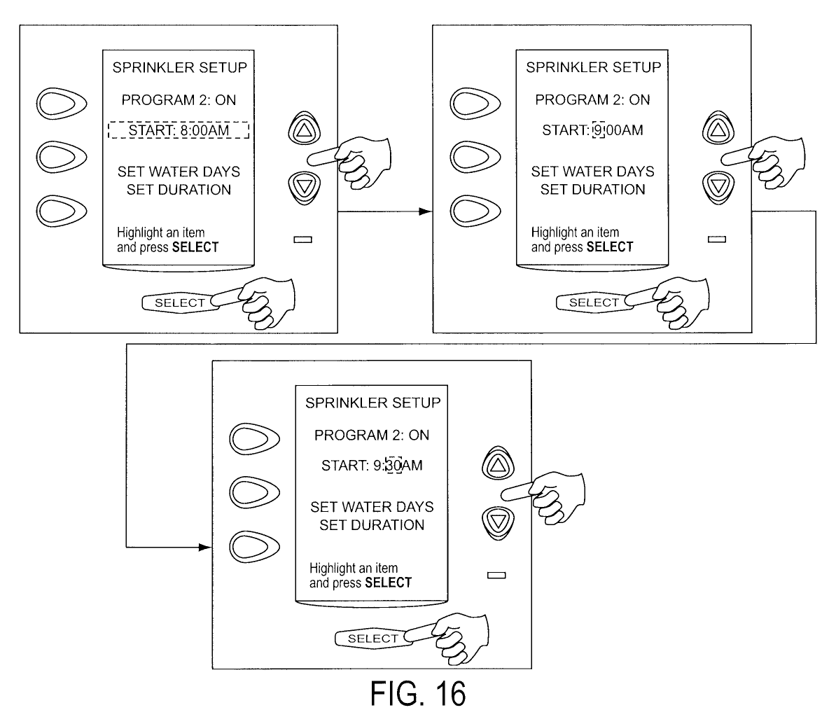

For example, as illustrated in FIG. 16, once the user has selected a program (FIG. 15), the user may scroll to highlight the “START” time, press the “SELECT” button, scroll to a desired start time, and then press “SELECT” button again to set the time. This may be repeated discretely for hours and minutes, as illustrated, or may be performed by scrolling, for example, fast and slow, up or down, chronologically.

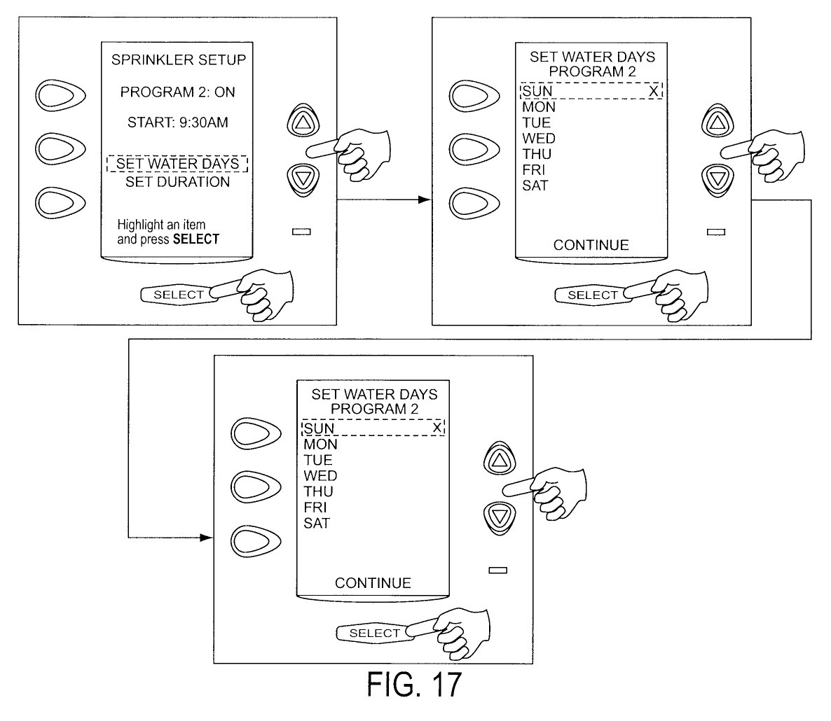

As illustrated in FIG. 17, the user may scroll to highlight the “SET WATER DAYS” option, and press the “SELECT” button to obtain a menu of days of the week. By scrolling and selecting/deselecting individual days, a user may program certain days to water for the program being set. The user may exit the current menu by highlighting “CONTINUE” and pressing the “SELECT” button.

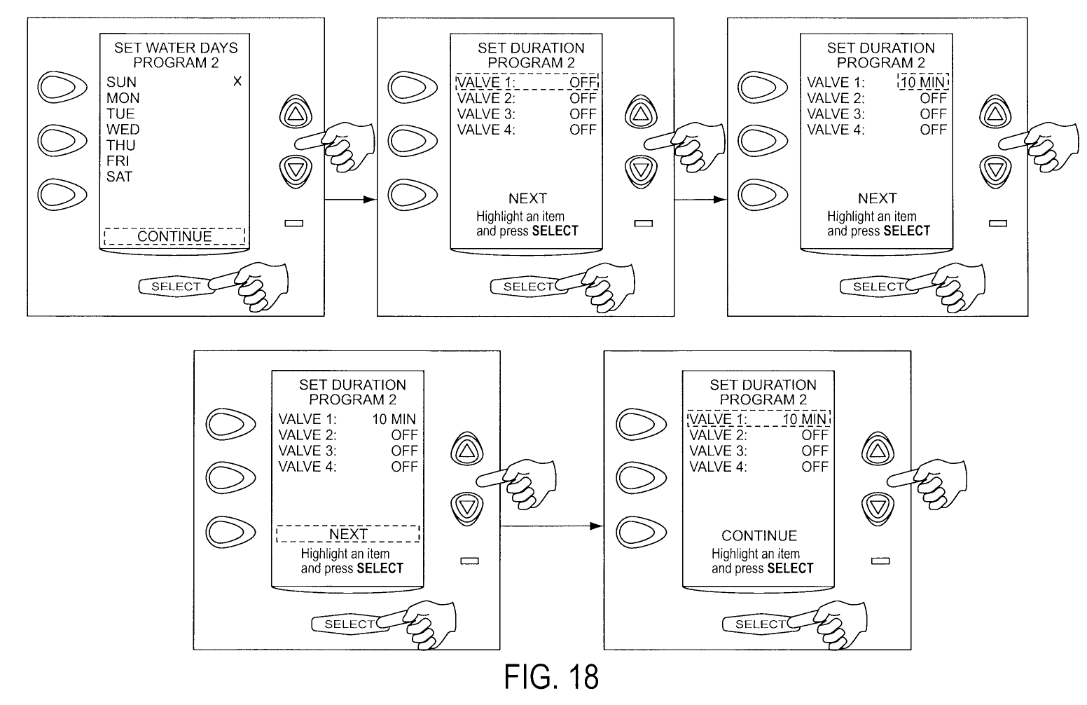

As illustrated in FIG. 18, this may automatically bring up a “SET DURATION” menu. This menu may allow the user to set durations for individual valves and/or zones as recognized by the sprinkler module, for example. In turn, each valve may be highlighted, selected and set to a desired run duration or off. The user may highlight “NEXT” and press the “SELECT” button to continue to other valves or zones until complete.

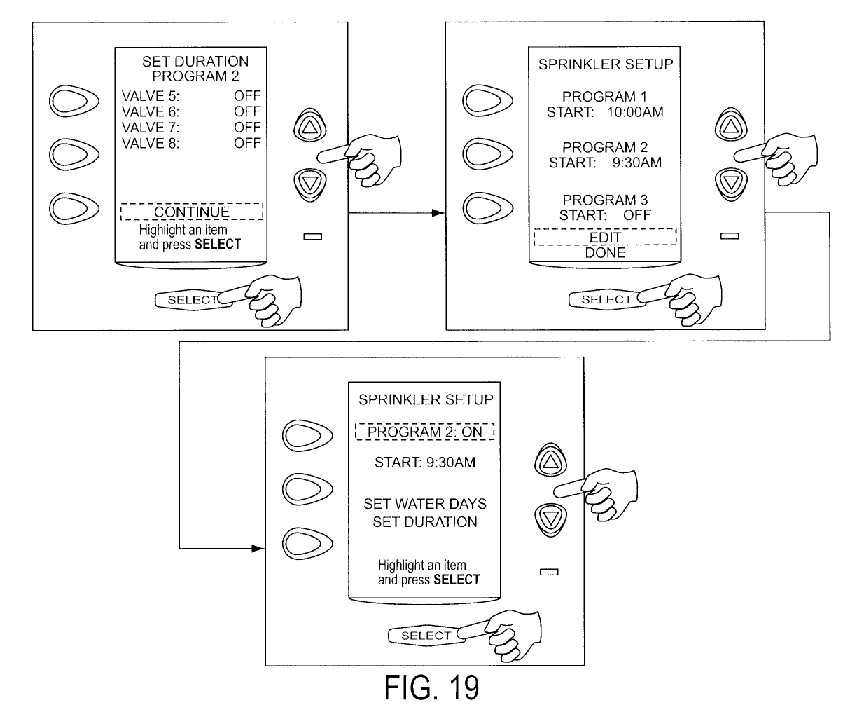

As illustrated in FIG. 19, once complete, the user may highlight “CONTINUE” and press the “SELECT” button to return to the “SPRINKLER SETUP” menu, where the user may highlight “DONE” and press the “SELECT” button to exit sprinkler setup. Otherwise, the user may highlight “EDIT” and press the “SELECT” button to continue programming sprinkler control, highlighting a desired program, and so forth as described above.

It should be understood that the menu system described above with respect to FIGS. 13-19 is only an example. However, it should also be understood that the menu system provided by the common user interface for setup and operation of the sprinkler control module may be intuitive and familiar to a user of the menu system for setup and control of a the master control. Thus, the expansion of a residential environmental management control system using a sprinkler control module may not only facilitate such expansion in an economical and competitive manner, but may also allow the user to retain familiarity, comfort and ease of user even with a more complex expanded system.

Although the present invention has been described with reference to specific embodiments, persons skilled in the art will recognize that changes may be made in form and detail without departing from the spirit and scope of the invention.

What is claimed is:

1. A residential environmental management control system, comprising:
a sprinkler module configured to control operation of a sprinkler system;
a master control configured to control operation of a first residential environmental system other than a sprinkler system and to control operation of the sprinkler module; and
a common user interface configured to receive user input to control operation of the first residential environmental system via the master control, and to receive user input to control the sprinkler system via the master control and the sprinkler module.

2. The system of claim 1, further comprising a master control housing, wherein the sprinkler module is mounted to the master control housing.

3. The system of claim 2, wherein the sprinkler module is mounted in a same area of the housing as the master control.

4. The system of claim 2, wherein the master control housing is configured to provide electrical shielding for the mounted sprinkler module.

5. The system of claim 1, further comprising a power supply associated with the master control, wherein the master control and the sprinkler module are electrically connected to and powered by the power supply.

6. The system of claim 5, wherein the master control and the sprinkler module are daisy chained to the power supply.

7. The system of claim 1, wherein the sprinkler module is configured to be directly controlled by the master control.

8. The system of claim 7, wherein the sprinkler module includes a dedicated processor configured to perform operations as programmed by the master control.

9. A sprinkler module kit for a residential environmental management control system, the kit including:
a sprinkler module configured to control operation of a sprinkler system;
mounting hardware configured to mount the sprinkler module; and
a communication cable configured to connect the sprinkler module to a master control of a residential environmental management control system to allow the master control to control operation of the sprinkler module.

10. The kit of claim 9, wherein the mounting hardware is configured to mount the sprinkler module to a housing of the master control.

11. The kit of claim 9, further comprising a power cable configured to electrically connect the sprinkler module to a power supply of the master control.

12. The kit of claim 11, further comprising an electrical connector configured to connect the sprinkler module to the master control such that the master control and the sprinkler module are daisy chained to the power supply of the master control when the electrical connector and the power cable are so connected.

13. The kit of claim 9, further comprising a power cable configured to electrically connect the sprinkler module to an electrical connector of the master control such that the sprinkler module and the master control are daisy chained to the power supply of the master control when the power cable is so connected.

14. A method of controlling operation of a sprinkler system using a residential environmental control system, comprising:
receiving user input at a common user interface;
communicating the received user input to a master control of a residential environmental control system; and
controlling operation of a sprinkler module with the master control to control operation of a sprinkler system.

15. The method of claim 14, wherein communicating the received user input to the master control programs the mater control, and controlling operation of the sprinkler module comprises the master control executing operations as programmed.

16. The method of claim 14, wherein communicating the received user input to the master control causes the master control to control operation of the sprinkler module by programming the sprinkler module.

17. A method of controlling operation of a sprinkler system using a residential environmental control system, comprising:
electrically connecting a sprinkler module to a master control of a residential environmental control system; and
providing user input to a common user interface in communication with the master control,
wherein the user input controls operation of a sprinkler system in communication with the sprinkler module via the master control.
